(19) United States
(12) Patent Application Publication
(10) Pub. No.: US 2019/0215899 A1
(43) Pub. Date: Jul. 11, 2019

(54) RELEASING SIGNALING RADIO BEARERS FOR CELL GROUPS

(71) Applicant: ZTE Corporation, Shenzhen (CN)

(72) Inventors: Zijiang Ma, Shenzhen (CN); Xin Wang, Shenzhen (CN); Jing Liu, Shenzhen (CN)

(21) Appl. No.: 16/162,376

(22) Filed: Oct. 16, 2018

Related U.S. Application Data
(63) Continuation of application No. PCT/CN2018/072021, filed on Jan. 10, 2018.

(51) Int. Cl. H04W 76/34; H04W 76/15; H04W 36/00

(52) U.S. Cl. CPC H04W 76/34; H04W 16/32; H04W 36/0069; H04W 76/15

(57) ABSTRACT

Methods, systems, and devices related to the management of lower layer resources for Signaling Radio Bearers (SRBs) in Dual Connectivity (DC) or Multi-Connectivity (MC) scenarios are described. In one exemplary aspect, a method for wireless communication includes operating a first wireless communication node in a wireless network. The wireless network comprises a master cell group and at least a secondary cell group, and the master cell group is configured with one or more split signaling radio bearers. The method also includes transmitting, from the first wireless communication node to a second wireless communication node in the wireless network, a message indicating a release of the one or more split signaling radio bearers of the master cell group, or a release of the secondary cell group.

### CROSS REFERENCE TO RELATED APPLICATIONS

This patent document is a continuation of and claims priority to International Patent Application No. PCT/CN2018/072021, filed on Jan. 10, 2018. The entire content of the before-mentioned patent application is incorporated by reference as part of the disclosure of this document.

### TECHNICAL FIELD

This patent document is directed generally to digital wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, are being discussed.

### SUMMARY OF PARTICULAR EMBODIMENTS

This document discloses methods, systems, and devices related to digital wireless communication, and more specifically, to techniques related to the management of lower layer resources for Signaling Radio Bearers (SRBs) in Dual Connectivity (DC) or Multi-Connectivity (MC) scenarios.

In one exemplary aspect, a method for wireless communication is disclosed. The method includes operating a first wireless communication node in a wireless network, wherein the wireless network comprises a master cell group and at least a secondary cell group, and wherein the first wireless communication node is configured with one or more split signaling radio bearers; and transmitting, from the first wireless communication node to a second wireless communication node in the wireless network, a message indicating a release of the one or more split signaling radio bearers, or a release of the secondary cell group. The message may be a radio resource control message.

In some embodiments, the one or more split signaling radio bearers are configured for the master cell group. In some implementations, the release of the one or more split signaling radio bearers of the master cell group comprises a release of lower-layer resources corresponding to the one or more split signaling radio bearers. In some embodiments, the message further indicates a release of one or more signaling radio bearers of the secondary cell group.

In some embodiments, the method includes receiving, at the first wireless communication node, an acknowledgement from the second wireless communication node, the acknowledgement configured to acknowledge the release of the one or more split signaling radio bearers of the master cell group, or the release of the secondary cell group.

In some embodiments, the message causes the second wireless communication node to release at least one of the following: (1) the one or more split signaling radio bearers of the master cell group, (2) lower-layer resources corresponding to the one or more signaling radio bearers of the secondary cell group, or (3) lower-layer resources corresponding to the secondary cell group. In some implementations, the first wireless communication node is a master node of the wireless network and the second wireless communication node is a secondary node of the wireless network.

In some embodiments, the method includes releasing, by the first wireless communication node, at least one of the following: (1) the one or more split signaling radio bearers of the master cell group, (2) lower-layer resources corresponding to the one or more signaling radio bearers of the secondary cell group, or (3) lower-layer resources corresponding to the secondary cell group. In some implementations, the first wireless communication node is a secondary node of the wireless network and the second wireless communication node is a master node of the wireless network.

In another exemplary aspect, a method for wireless communication is disclosed. The method includes operating a wireless communication node in a wireless network, wherein the wireless network comprises a master cell group and at least a secondary cell group; and transmitting, from the wireless communication node to a mobile device, a message indicating a release of the secondary cell group or a release of one or more signaling radio bearers of the secondary cell group.

In some embodiments, the wireless communication node is a master communication node in the wireless network and the message indicates the release of the secondary cell group. In some embodiments, the wireless communication node is a secondary communication node in the wireless network and the message indicates the release of the lower layer resources corresponding to the one or more signaling radio bearers of the secondary cell group.

In some embodiments, the method also includes receiving, at the wireless communication node, an acknowledge from the mobile device, the acknowledge configured to acknowledge the release of the lower layer resources corresponding to the one or more signaling radio bearers of the secondary cell group.

In another exemplary aspect, a method for wireless communication is disclosed. The method includes receiving, from a communication node in a wireless network, a message indicating a release of a cell group in the wireless network; releasing lower layer resources for the cell group; and refraining from monitoring one or more failures of the cell group.

In some embodiments, the cell group is a secondary cell group in the wireless network. In some embodiments, the lower layer resources comprise lower layer resources corresponding to all data radio bearers and all signaling radio bearers of the cell group.

In another exemplary aspect, a wireless communications apparatus comprising a transmitter is disclosed. The transmitter is configured to transmit, from a first wireless communication node to a second wireless communication node in the wireless network, a message indicating a release of the one or more split signaling radio bearers of a master cell group, or a release of a secondary cell group. The message may be a radio resource control message. The wireless communications apparatus may also include processor electronics for implementing methods described in the present document.

In some embodiments, the release of the one or more split signaling radio bearers of the master cell group comprises a release of lower-layer resources corresponding to the one or more split signaling radio bearers. In some embodiments, the message further indicates a release of one or more signaling radio bearers of the secondary cell group.

In some embodiments, the apparatus includes a receiver configured to receive, at the first wireless communication node, an acknowledgement from the second wireless communication node, the acknowledgement configured to acknowledge the release of the one or more split signaling radio bearers of the master cell group, or the release of the secondary cell group.

In some embodiments, the message causes the second wireless communication node to release at least one of the following: (1) the one or more split signaling radio bearers of the master cell group, (2) lower-layer resources corresponding to the one or more signaling radio bearers of the secondary cell group, or (3) lower-layer resources corresponding to the secondary cell group. In some implementations, the first wireless communication node is a master node of the wireless network and the second wireless communication node is a secondary node of the wireless network.

In some embodiments, the apparatus includes a processor configured to release, by the first wireless communication node, at least one of the following: (1) the one or more split signaling radio bearers of the master cell group, (2) lower-layer resources corresponding to the one or more signaling radio bearers of the secondary cell group, or (3) lower-layer resources corresponding to the secondary cell group. In some implementations, the first wireless communication node is a secondary node of the wireless network and the second wireless communication node is a master node of the wireless network.

In another exemplary aspect, a wireless communications apparatus comprising a transmitter is disclose. The transmitter is configured to transmit, from the wireless communication node to a mobile device, a message indicating a release of the secondary cell group or a release of one or more signaling radio bearers of the secondary cell group.

In some embodiments, the wireless communication node is a master communication node in the wireless network and the message indicates the release of the secondary cell group. In some embodiments, the wireless communication node is a secondary communication node in the wireless network and the message indicates the release of the lower layer resources corresponding to the one or more signaling radio bearers of the secondary cell group.

In some embodiments, the apparatus includes a receiver configured to receive, at the wireless communication node, an acknowledge from the mobile device, the acknowledge configured to acknowledge the release of the lower layer resources corresponding to the one or more signaling radio bearers of the secondary cell group.

In another exemplary aspect, a wireless communications apparatus is disclosed. The apparatus includes a receiver configured to receive, from a communication node in a wireless network, a message indicating a release of a cell group in the wireless network. The apparatus also includes a processor configured to release lower layer resources for the cell group and refrain from monitoring one or more failures of the cell group.

In some embodiments, the cell group is a secondary cell group in the wireless network. In some embodiments, the lower layer resources include lower layer resources corresponding to all data radio bearers and all signaling radio bearers of the cell group.

In yet another exemplary aspect, the various techniques described herein may be embodied as processor-executable code and stored on a computer-readable program medium.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows an exemplary schematic diagram of a system architecture for Dual Connectivity (DC).

FIG. 2 shows a schematic diagram of a Layer 2 (L2) radio protocol stack of a Master Cell Group (MCG) Radio Bearer (RB).

FIG. 3A shows a schematic diagram of a L2 radio protocol stack of a MCG Split RB on two network elements.

FIG. 3B shows an example of a L2 radio protocol stack of a Secondary Cell Group (SCG) Radio Bearer (RB).

FIG. 4A shows an example of decoupling higher-layer entities from lower-layer entities in a Dual Connection (DC) or Multi-Connection (MC) mode.

FIG. 4B shows another example of decoupling higher-layer entities from lower-layer entities in a Dual Connection (DC) or Multi-Connection (MC) mode.

FIG. 5 is a flowchart representation of a method for wireless communication.

FIG. 6 is a flowchart representation of another method for wireless communication.

FIG. 7 is a flowchart representation of another method for wireless communication.

FIG. 8 shows an example of a wireless communication system where techniques in accordance with one or more embodiments of the present technology can be applied.

FIG. 9 is a block diagram representation of a portion of a radio station.

### DETAILED DESCRIPTION

With the continuous development of wireless communication technologies, a wide range of wireless communication services are emerging, which will greatly increase the demand for bandwidth in wireless communication systems. The development of the new generation of wireless communication—5G New Radio (NR) communication—is a part of an ongoing mobile broadband evolution process to meet the requirements of increasing network demand. NR will provide greater throughput to allow more users to connect at the same time. Aspects such as energy consumption, device cost, spectral efficiency, and latency are important to meeting the needs of various communication scenarios.

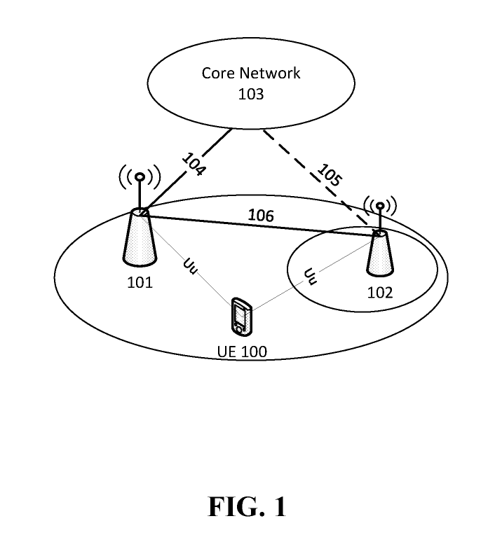

As NR emerges in the wireless technology area, User Equipment (UE) will be capable of supporting existing protocols (e.g., Long Term Evolution (LTE)) as well as NR protocols at the same time. FIG. 1 shows an exemplary schematic diagram of a system architecture for Dual Connectivity (DC). Some example embodiments of DC may include a system configuration, or a mode of operation of a wireless device, in which user devices may operate with two logically separate communication connections to the network. The current base station that is serving currently serving the UE (referred to as the first network element 101) and coupled to the core network 103 may select a suitable another base station for the UE 100 to function as the second network element 102. For example, the suitable based station can be selected by selecting a candidate base station and comparing the channel quality of the candidate base station (the channel between the candidate base station and the UE) with a predetermined threshold. Upon selection, both base stations can provide radio resources to the UE 100 for data transmission on the user plane.

On the wired interface side (e.g., backhaul connections), the first network element 101 and the core network 103 establish one or more interfaces 104 for the UE 100 (e.g., a control plane interface and a user plane interface). The second network element 102 and the core network 103 may establish one or more interfaces105 for the UE 100 (e.g., a control plane interface and/or a user plane interface). An interface 106 (e.g., Xn interface) inter-connects the two network elements.

On the wireless interface side, the first and the second network elements (101 and 102) may provide radio resources using the same or different Radio Access Technologies (RATs). Each of the network element can schedule transmissions with the UE 100 independently. One network element functions as the master node (MN) (e.g., the first network element 101), and the other network element functions as the secondary node (SN) (e.g., the second network element 102). In some cases, the UE 100 can be connected to more than two nodes, with one node functioning as the MN and the remaining nodes functioning as the SNs.

In some embodiments, a UE can support a LTE-NR dual connection. For example, one of the typical LTE-NR dual connectivity architectures can be set up as follows: the MN is an LTE RAN node (e.g., eNB) and the SN is an NR RAN node (e.g., gNB). The eNB and the gNB are connected the Evolved Packet Core (EPC) network (e.g., LTE core network). The architecture shown in FIG. 1 can also be modified to include various master/secondary node configurations. For example, a NR RAN node can be the MN and the LTE RAN node can be the SN. In such case, the core network for the master NR RAN node is a Next Generation Converged Network (NG-CN), which may also be referred to as the 5G Core Network (5GC). In each of the dual connection scenarios, one network (e.g., LTE network) is responsible for resolving coverage, while the other (e.g., NR network) is responsible for improving throughput. The architecture shown in FIG. 1 can also be extended to support Multi-Connectivity (MC), with one MN and multiple SNs providing both coverage and throughput for UE access.

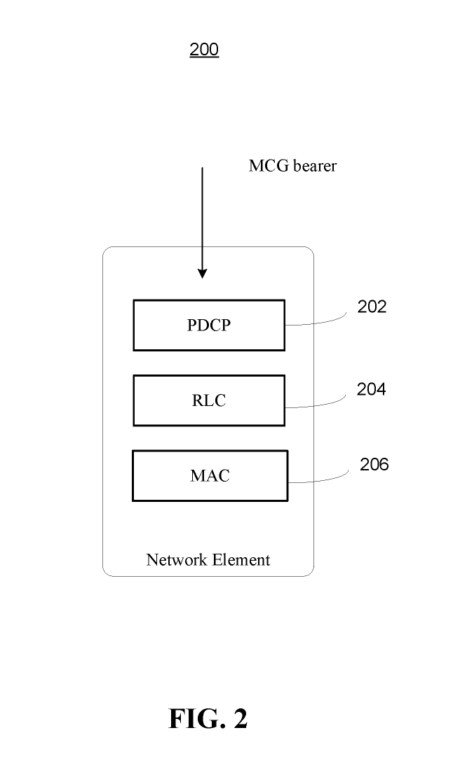

In wireless communication, Radio Bearer (RB) is a virtual concept to define how data and/or signaling from UE are treated when it travels across the network. There are two categories of RBs: Data Radio Bearers (DRBs) for carrying User Plane (UP) traffic, and Signaling Radio Bearers (SRBs) for carrying Control Plane (CP) traffic. FIG. 2 shows a schematic diagram of the Layer 2 (L2) radio protocol stack of a Master Cell Group (MCG) RB. The protocol stack 200 includes a Packet Data Convergence Protocol (PDCP) entity 202, a Radio Link Control (RLC) entity 204, and a Media Access Control (MAC) entity 206. For an SRB carrying CP traffic, a Radio Resource Control (RRC) entity is located above the L2 protocol stack.

If a network element is responsible for data transmissions with the UE, that network element establishes a serving cell and at least one DRB for carrying data traffic with UE. For example, if the secondary node (e.g., gNB) performs data transmissions with a UE, it can establish a Primary Cell of a Secondary Cell Group (PScell) and at least one Secondary Cell Group (SCG) DRB. Furthermore, the secondary node (e.g., gNB) can establish one or more Signaling Radio Bearers (SRBs) for carrying a typically small amount of control traffic with the UE.

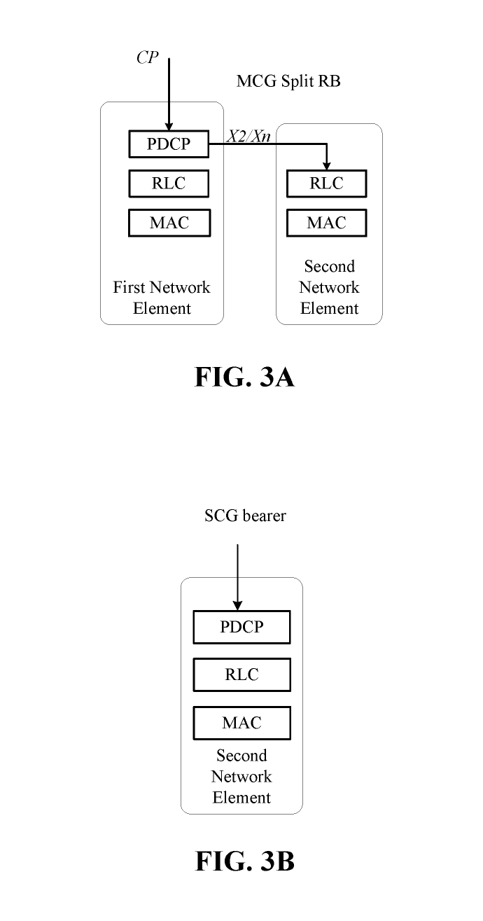

In DC or MC scenarios, Signaling Radio Bearers (SRBs) can be classified into the following categories: Master Cell Group (MCG) split SRB1 (also referred to as SRB1S), Master Cell Group (MCG) split SRB2 (also referred to as SRB2S), and Secondary Cell Group (SCG) SRB (also referred to as SRB3). FIGS. 3A-3B show examples of the different types of SRBs. For example, as shown in FIG. 3A, the L2 protocol stack of a MCG split SRB (either SRB1S or SRB2S) is disposed on two serving network elements. The MCG split SRB is configured with two sets of RLC entities and MAC entities. The CP interface is on the first network element (e.g., the MN), and the PDCP entity are located at the same network element. FIG. 3B shows an example of SCG SRB (i.e., SRB3) configured on a single network element (i.e., SN). The L2 radio protocol stack for SRB3 is similar to the MCG RB as shown in FIG. 2. It is noted that while the descriptions in this patent document focus on the MCG split RBs, similar types of split radio bearers may also be configured for the SCG such that each of the SCG split RB has two sets of lower layer resources (e.g., RLC and MAC entities) disposed on two serving network elements (i.e., MN and SN) and one set of higher layer resources (e.g., PDCP entity) disposed on one network element (i.e., SN).

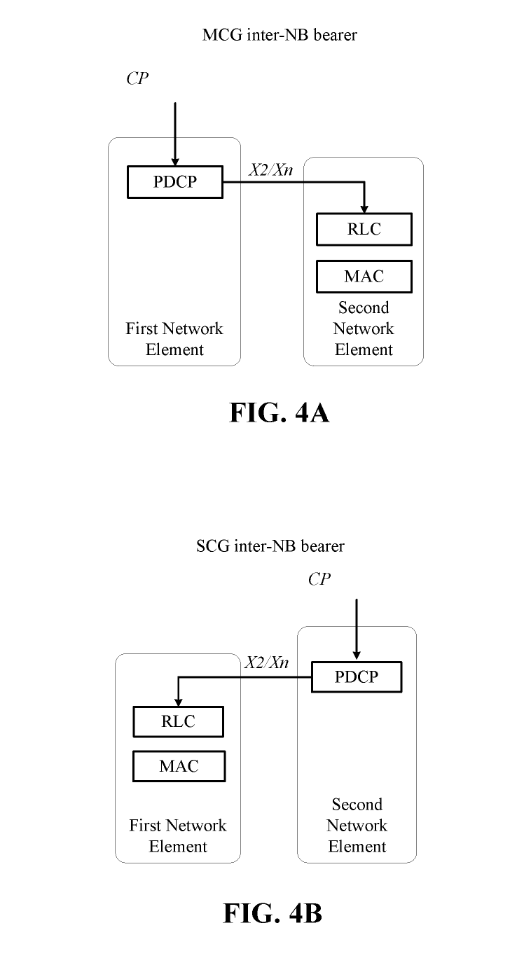

The above SRB types are designed to be Bearer Type Harmonization. That is, the UE does not distinguish between the network element(s) corresponding to the PDCP entity. For example, in some embodiments, the bearer types may all be configured as an NR PDCP entity. Such design also allows the higher layer entities (e.g., the PDCP entity) to be decoupled with the lower layer entities (e.g., the RLC and MAC entities). FIGS. 4A-4B show examples of decoupling the higher layer entities from the lower layer entities in DC or MC mode. FIG. 4A shows an example of an MCG inter-NB bearer. In this example, the CP interface and higher layer entities are located at the first network element (i.e., the MN). The lower layer entities are decoupled and located at the second network element (i.e., the SN). FIG. 4B shows an example of an SCG inter-NB bearer. In this example, the CP interface and high-layer entities are located at the second network element (i.e., the SN). The low-layer entities are decoupled and located at the first network element (i.e., the MN).

With the development of communication standards, a new bearer type for DRB—SN terminated MCG bearer—was introduced to allow the decoupling of lower layer and higher layer resources for data traffic. For example, the PDCP entity for the SN terminated MCG bearer is configured on the SN while the RLC and MAC entities are configured on the MN only. One advantage of using the new DRB type is that the network side no longer needs to configure RLC or MAC entity on the SN for the UE, and UE does not need to monitor signal quality, such as SN radio link failure (RLF), on the SN side, or detect SN failures. This is particularly useful when the coverage of the SN is low for data traffic yet it is still desirable for the UE to perform control transmissions with the SN.

However, the new DRB type—SN terminated MCB bearer—cannot fully stop the UE from monitoring signal quality or failures on the SN if an SRB is established between the UE and the SN. Currently, once an SRB is established, the SRB is not released until the SN is removed or the UE changes to another SN. The RLC entity for the SRB thus persists to exist, causing the UE to continuously monitor SN signal quality and SN failures even when it is not necessary to do so.

This patent document describes methods and corresponding apparatus to allow the release of lower layer resources of SRB(s) and allow the UE to skip SN failure detection and/or SN signal quality monitoring when necessary, thereby reducing bandwidth and power consumption by the UE. Details of the techniques are described in the following embodiments. In each of the following embodiments, the network can establish one or more MCG split SRBs (e.g., SRB1S and/or SRB2S) using the following steps:

Step A.1: The MN first transmits a message (e.g., “SN ADDITION REQUEST”) to the SN. The message includes an information element, such as “Requested MCG split SRBs,” to establish the one or more MCG split SRBs.

Step A.2: After receiving the request message, the SN sends a response (e.g., “SN ADDITION REQUEST ACKNOWLEDGE”) to the MN. The message includes an information element, such as “Admitted MCG split SRBs,” to inform the MN of the established MCG split SRBs. The MN and SN may proceed to the release of lower layer resources corresponding to the SRBs when appropriate.

### Example Embodiment 1

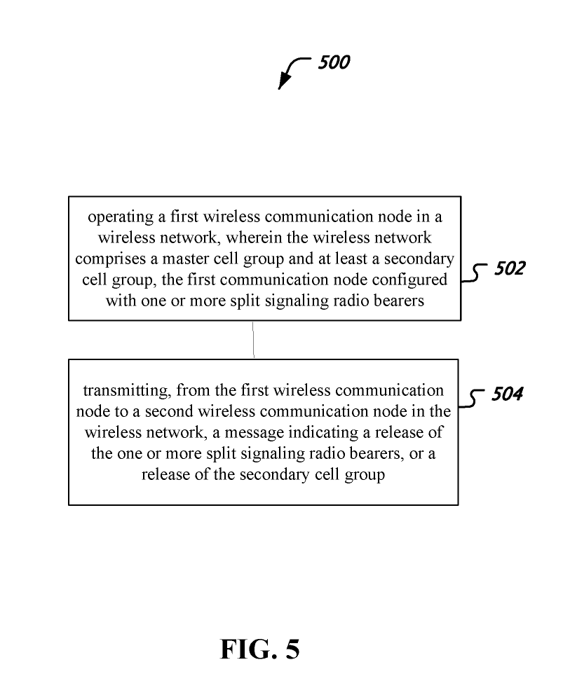

This embodiment describes exemplary signaling procedures between the MN and the SN regarding the management of SRBs. FIG. 5 is a flowchart representation of a method 500 for wireless communication. The method 500 includes, at 502, operating a first wireless communication node in a wireless network. The wireless network comprises a master cell group and at least a secondary cell group. The first wireless communication node is configured with one or more split signaling radio bearers. The method 500 also includes, at 504, transmitting, from the first wireless communication node to a second wireless communication node in the wireless network, a message indicating a release of the one or more split signaling radio bearers, or a release of the secondary cell group.

The split signaling radio bearers of the master cell group (e.g., SRB1S and/or SRB2S) have lower layer resources in both the master cell group and the secondary cell group (also known as the MCG leg and the SCG leg). In some embodiment, the message indicates a release of the one or more split signaling radio bearers of the master cell group. In some implementations, the message indicates a release of lower-layer resources corresponding to the one or more split signaling radio bearers of the master cell group. After the lower-layer resources of secondary cell group are released, the split signaling radio bearers can be seen as released, or changed to signaling radio bearers of master cell group that are configured with only lower-layer resources of master cell group. Therefore, in such cases, the message also indicates the release of the split signaling radio bearers of the master cell group.

Either the MN or the SN can initiate the release process. Both cases are described in further details below.

The MN Initiates the SRB Release Process

When the MN initiates the SRB release process, the MN can perform the following steps:

Step B.1: The MN sends a message (e.g., “SN MODIFICATION REQUEST”) to the SN. The message can include an information element, such as “Requested release MCG split SRBs,” to request the release of lower layer resources corresponding to MCG split SRBs (e.g., SRB1S and/or SRB2S) on the SN. In some embodiments, the message can include an information element, such as “Requested SCG release,” to request the release of the SCG.

Step B.2: After receiving the message, the SN transmits a response message (e.g., “SN MODIFICATION REQUEST ACKNOWLEDGE”) to the MN. The message can include an information element, such as “Admitted release MCG split SRBs,” to acknowledge the release of lower layer resources corresponding to the MCG split SRBs on the SN. In some embodiments, the message can include an information element, such as “Admitted SCG release,” to acknowledge the release of the SCG.

The SN Initiates the SRB Release Process

When the SN initiates the SRB release process, the SN can perform the following steps:

Step C.1: The SN sends a message (e.g., “SN MODIFICATION REQUIRED”) to the MN. The message can include an information elements, such as “Requested release MCG split SRBs,” to request the release of lower layer resources corresponding to the split SRBs (e.g., SRB1S and/or SRB2S) on the SN. In some embodiments, the message can include an information element, such as “Requested SCG release,” to request the release of the SCG.

Step C. 2: After receiving the message, the MN transmits a response message (e.g., “SN MODIFICATION CONFIRM”) to the SN. The message includes an information element, such as “Admitted release MCG split SRBs,” to acknowledge the release of lower layer resources corresponding to the MCG split SRBs on the SN. In some embodiments, the message can include an information element, such as “Admitted SCG release,” to acknowledge the release of the SCG.

The Special Case of SRB3

Currently, the SRB3 is only configured on the SN side; the MN is agnostic about its existence. Therefore, the SN needs to initiate the establishment and release of SRB3 by itself

There is no bearer between the SN and the UE prior to the establishment of the SRB3. Therefore, the SN needs to pass the information to MN so that the MN can relay the information to the UE for establishing the SRB3.

In order to establish SRB3, the SN can perform the following steps:

Step D.1: The SN determines that it needs to establish one or more SRB3s.

Step D.2: The SN configures lower layer resources corresponding to the one or more SRB3s, such as the corresponding SCG RLC bearer(s).

Step D.3: The SN passes information of the one or more SRB3s to the MN so that the MN can relay the information to the UE.

The MN will then relay the relevant SRB3 information via a message (e.g., an RRC reconfiguration message) to establish the SRB3 between the SN and the UE. After the SRB3 is established, the SN can directly communicate with the UE without going through the MN.

### Example Embodiment 2

This embodiment describes exemplary operations performed by the network regarding the management of SRBs (particularly, the release of lower layer resources of the split SRBs on the SN and/or the release of SRB3s). In this embodiment, the includes both the MN and SN.

In some implementations, after receiving a request from the MN to release lower layer resources for the MCG split SRBs on the SN (or imitating the process to do so), the SN releases the lower layer resources corresponding to the MCG split SRBs. The SN then transmits an acknowledgment to the MN as described in Example Embodiment 1. From MN's perspective, the MCG split SRBs now become MCG SRBs with only one set of lower layer resources configured on the MN.

The Special Case of SRB3

With an established SRB3, the SN can communicate directly with UEs via the Uu interface to facilitate its release. The SN may decide to release one or more SRB3s based on certain conditions. The conditions can be at least one of the following:

1) The SN receives a request from the MN to release low-layer resources corresponding to all SN-side DRBs.

2) The SN requests to release low-layer resources corresponding to all SN-side DRBs, and the MN acknowledges the request.

3) The low-layer resources corresponding to all the DRBs on the SN have been released.

4) The SN receives a request from the MN to release low-layer resources corresponding to all the DRBs and all the MCG split SRBs.

5) The SN requests to release low-layer resources corresponding to all the DRBs and all the MCG split SRBs, and the MN acknowledges the request.

6) The low-layer resources corresponding to all the DRBs and all the MCG split SRBs have been released.

7) The SN receives a message to release the SCG.

In some embodiments, after determining that one of the conditions has been triggered, the SN first transmits a request to the UE to indicate the release, and waits for an acknowledgement from the UE before releasing the SRB3s.

In some embodiments, the SN releases the one or more SRB3s after it decides that one of the conditions has been triggered. For example, after receiving a request from the MN to release the SCG (or initiating the process to do so), the SN releases the lower layer resources corresponding to all the DRBs and split SRBs if there is any established DRB(s) and/or split SRB(s) on the SN. The SN can release the SCG RLC bearers corresponding to all the DRBs. In some implementations, the SN further releases lower layer resources corresponding to any of the MCG split SRBs. If there is any SRB3 configured on the SN, the SN can decide to release the SRB3(s) as well.

It is noted that the release of an SRB3 includes releasing lower layer resources corresponding to the SRB3. In some embodiments, the release of an SRB3 also includes releasing higher layer resources. That is, once an SRB3 is released, both the lower layer and higher layer resources are released.

### Example Embodiment 3

This embodiment describes exemplary signaling procedures between the network and the UE regarding the management of SRBs (particularly, the release of lower layer resources of the SRBs). In this embodiment, the network includes both the MN and SN.

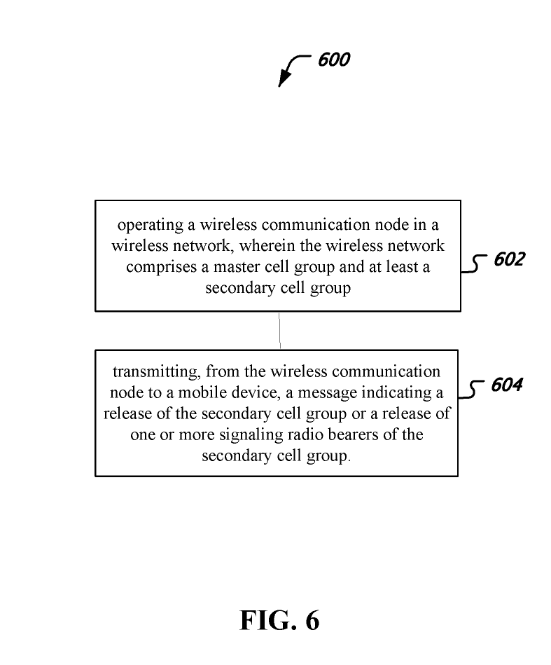

FIG. 6 is a flowchart representation of a method 600 for wireless communication. The method 600 includes, at 602, operating a wireless communication node in a wireless network. The wireless network comprises a master cell group and at least a secondary cell group. The method also includes, at 604, transmitting, from the wireless communication node to a mobile device, a message indicating a release of the secondary cell group or a release of one or more signaling radio bearers of the secondary cell group.

In some embodiments, after the SN releases all the DRBs and SRBs as described in Example Embodiment 2, the MN transmits a message (e.g., an RRC message) to the UE to indicate the release of the SCG so that the UE can also release the SCG. The message can include an information element, such as “SecondaryCellGroupToReleaseList.” The message can also include a group identifier (e.g., CellGroupld) to identify the current cell of the SN.

The Special Case of SRB3

In some embodiments, after the SN determines to release the SRB3(s), the SN can perform the following steps:

Step E.1: The SN sends a message (e.g., an RRC message) to the UE via the Uu interface. The message includes an information element to indicate the release of SRB3(s).

Step E.2: The SN receives an RRC response message from the UE via the Uu interface. The message acknowledges the release of SRB3.

The SN may then proceed to releasing SRB3 accordingly. In some embodiments, however, the RRC response message indicates that the UE declines to release the SRB3(s). The SN will not release SRB3(s) in such cases.

### Example Embodiment 4

The embodiment describes exemplary operations of the UE after it receives a message from the network to release a cell group. The release of the cell group includes releasing lower layer resources of the cell group.

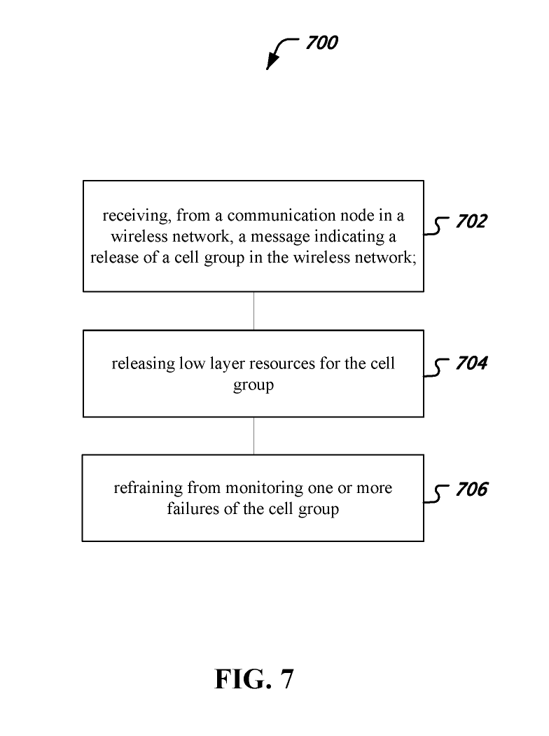

FIG. 7 is a flowchart representation of a method 700 for wireless communication. The method 700 includes, at 702, receiving, from a communication node in a wireless network, a message indicating a release of lower layer resources associated with a cell group in the wireless network. The method 700 includes, at 704, releasing the low layer resources for the cell group. The method 700 also includes, at 706, refraining from monitoring one or more failures of the cell group. For example, failures of the SCG can include one or more of the following: an SCG RLF, an SN change failure, or an SCG reconfiguration with sync failure.

More specifically, the UE can perform the following operation regarding the release of SRB(s):

Step F.1: The UE receives a message (e.g., an RRC reconfiguration message) from the network.

Step F.2: The UE reads the message. If the message includes an information element (e.g., “secondaryCellGroupToReleaseList”) that indicates a release of the SCG, the UE releases the SCG. In particular, the UE releases lower layer resources of the SCG.

Step F.3: The UE stops monitoring SN signal quality and also stops detecting and/or reporting SCG failures upon detecting one of the following conditions:

1) The message includes an information element to release the SCG.

2) The message indicates a release of all SN-side DRBs.

3) The message indicates a release of all SN-side DRBs and SRBs (including SRB1S, SRB2S, and SRB3).

It is again noted that, while the foregoing descriptions focus on the MCG split SRBs, the disclosed techniques can also be applied to split RBs configured for the SCG (e.g., a split RB that has lower layer resources configured on both the MN and SN, with higher layer resources configured on only the SN).

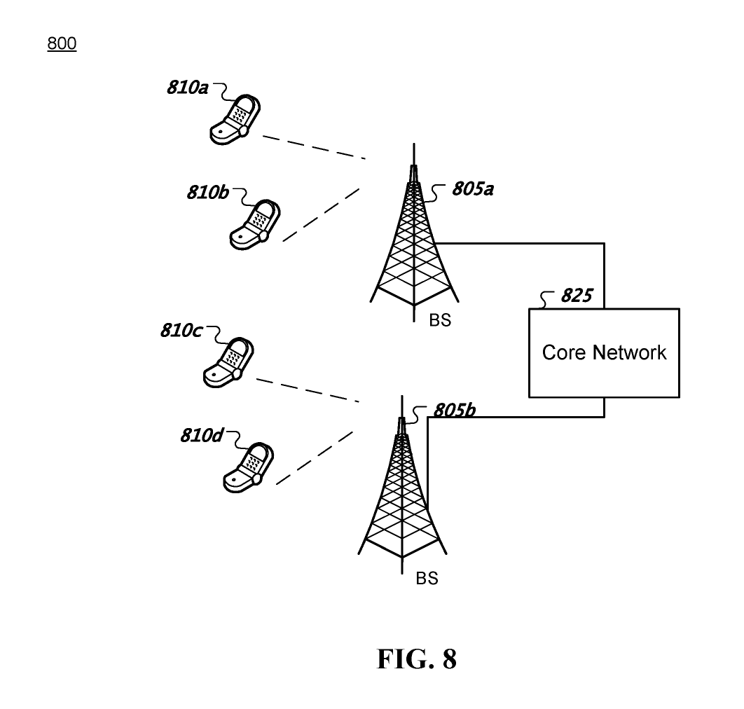

FIG. 8 shows an example of a wireless communication system where techniques in accordance with one or more embodiments of the present technology can be applied. A wireless communication system 800 can include one or more base stations (BSs) 805a, 805b, one or more wireless devices 810a, 810b, 810c, 810d, and a core network 825. A base station 805a, 805b can provide wireless service to wireless devices 810a, 810b, 810c and 810d in one or more wireless sectors. In some implementations, a base station 805a, 805b includes directional antennas to produce two or more directional beams to provide wireless coverage in different sectors.

The core network 825 can communicate with one or more base stations 805a, 805b. The core network 825 provides connectivity with other wireless communication systems and wired communication systems. The core network may include one or more service subscription databases to store information related to the subscribed wireless devices 810a, 810b, 810c, and 810d. A first base station 805a can provide wireless service based on a first radio access technology, whereas a second base station 805b can provide wireless service based on a second radio access technology. The base stations 805a and 805b may be co-located or may be separately installed in the field according to the deployment scenario. The wireless devices 810a, 810b, 810c, and 810d can support multiple different radio access technologies.

In some implementations, a wireless communication system can include multiple networks using different wireless technologies. A dual-mode or multi-mode wireless device includes two or more wireless technologies that could be used to connect to different wireless networks.

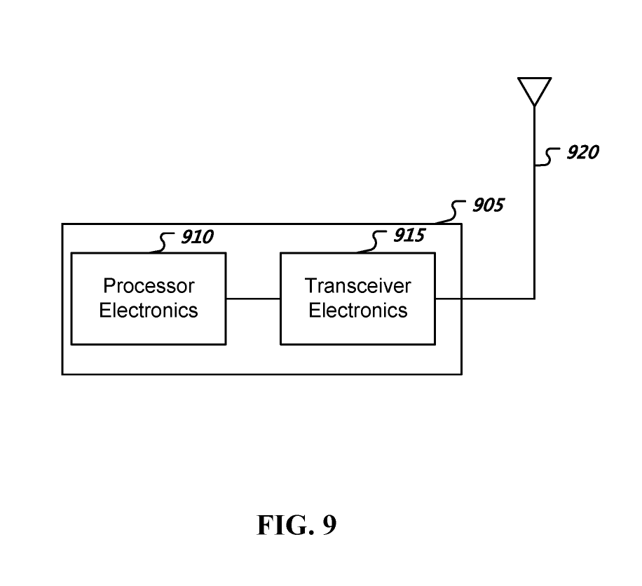

FIG. 9 is a block diagram representation of a portion of a radio station. A radio station 905 such as a base station or a wireless device (or UE) can include processor electronics 910 such as a microprocessor that implements one or more of the wireless techniques presented in this document. The radio station 905 can include transceiver electronics 915 to send and/or receive wireless signals over one or more communication interfaces such as antenna 920. The radio station 905 can include other communication interfaces for transmitting and receiving data. Radio station 905 can include one or more memories (not explicitly shown) configured to store information such as data and/or instructions. In some implementations, the processor electronics 910 can include at least a portion of the transceiver electronics 915. In some embodiments, at least some of the disclosed techniques, modules or functions are implemented using the radio station 905.

It is thus evident that methods and corresponding apparatus relating to the management of SRB(s) are disclosed. The disclosed techniques allow the UE operating in a DC or MC mode to skip SN failure detection and/or SN signal quality monitoring of the SN when necessary, thereby reducing bandwidth and power consumption by the UE.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment.

A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for wireless communication, comprising:
operating a first wireless communication node in a wireless network, wherein the wireless network comprises a master cell group and at least a secondary cell group, and wherein one or more split signaling radio bearers are established by the first wireless communication node; and
transmitting, from the first wireless communication node to a second wireless communication node in the wireless network, a message indicating a release of the one or more split signaling radio bearers.

2. The method of claim 1, wherein the one or more split signaling radio bearers are configured for the master cell group.

3. The method of claim 2, wherein the release of the one or more split signaling radio bearers of the master cell group comprises a release of lower-layer resources corresponding to the one or more split signaling radio bearers of the master cell group.

4. The method of claim 1, wherein the message further indicates a release of one or more signaling radio bearers of the secondary cell group.

5. The method of claim 2, comprising:
receiving, at the first wireless communication node, an acknowledgement from the second wireless communication node, the acknowledgement configured to acknowledge the release of the one or more split signaling radio bearers.

6. The method of claim 2, wherein the message causes the second wireless communication node to release the one or more split signaling radio bearers.

7. The method of claim 6, wherein the first wireless communication node is a master node of the wireless network and the second wireless communication node is a secondary node of the wireless network.

8. The method of claim 2, further comprising:
releasing, by the first wireless communication node, at least one of the following:
(1) the one or more split signaling radio bearers of the master cell group,
(2) lower-layer resources corresponding to the one or more signaling radio bearers of the secondary cell group, or
(3) lower-layer resources corresponding to the secondary cell group.

9. The method of claim 8, wherein the first wireless communication node is a secondary node of the wireless network and the second wireless communication node is a master node of the wireless network.

10. The method of claim 1, wherein the message is a radio resource control message.

11. An apparatus for wireless communication comprising a processor that is configured to carry out a method comprising:
operating a first wireless communication node in a wireless network, wherein the wireless network comprises a master cell group and at least a secondary cell group, and wherein one or more split signaling radio bearers are established by the first wireless communication node; and
transmitting, from the first wireless communication node to a second wireless communication node in the wireless network, a message indicating a release of the one or more split signaling radio bearers.

12. The apparatus of claim 11, wherein the one or more split signaling radio bearers are configured for the master cell group.

13. The apparatus of claim 12, comprising:
receiving, at the first wireless communication node, an acknowledgement from the second wireless communication node, the acknowledgement configured to acknowledge the release of the one or more split signaling radio bearers.

14. The apparatus of claim 12, wherein the message causes the second wireless communication node to release the one or more split signaling radio bearers.

15. The apparatus of claim 14, wherein the first wireless communication node is a master node of the wireless network and the second wireless communication node is a secondary node of the wireless network.

16. A non-transitory computer readable medium having code stored thereon, the code when executed by a processor, causing the processor to implement a method, comprising:
operating a first wireless communication node in a wireless network, wherein the wireless network comprises a master cell group and at least a secondary cell group, and wherein one or more split signaling radio bearers are established by the first wireless communication node; and
transmitting, from the first wireless communication node to a second wireless communication node in the wireless network, a message indicating a release of the one or more split signaling radio bearers.

17. The non-transitory computer readable medium of claim 16, wherein the one or more split signaling radio bearers are configured for the master cell group.

18. The non-transitory computer readable medium of claim 17, wherein the method further includes:
receiving, at the first wireless communication node, an acknowledgement from the second wireless communication node, the acknowledgement configured to acknowledge the release of the one or more split signaling radio bearers.

19. The non-transitory computer readable medium of claim 17, wherein the message causes the second wireless communication node to release the one or more split signaling radio bearers.

20. The non-transitory computer readable medium of claim 19, wherein the first wireless communication node is a master node of the wireless network and the second wireless communication node is a secondary node of the wireless network.
